(19) United States
(12) Patent Application Publication
(10) Pub. No.: US 2003/0033519 A1
(43) Pub. Date: Feb. 13, 2003

(54) System and method for programming network nodes

(75) Inventors: Charles R. Buckman, Austin, TX (US); Dennis J. Cox, Austin, TX (US); Donovan M. Kolbly, Austin, TX (US); Craig S. Cantrell, Austin, TX (US); Brain C. Smith, Fort Worth, TX (US); Jon H. Werner, Austin, TX (US); Marc Willebeek-LeMair, Austin, TX (US); J. Wayne Blackard, Austin, TX (US); Francis S. Webster III, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: Tippingpoint Technologies,Inc.

(21) Appl. No.: 09/928,771

(22) Filed: Aug. 13, 2001

(51) Int. Cl. H04L 9/00

(52) U.S. Cl. 713/153

(57) ABSTRACT

A system and method programs network nodes of a packet-based network to provide services. A service creation tool provides an interface for defining packet processing behaviors in a domain specific programming language and package the service for deployment to the network. A service control center deploys, provisions and monitors the service on programmable nodes. Network processors associated with the programmable nodes have packet processing behaviors translated from the programming language to operation code with a network processor abstraction layer. The service control center and network nodes use a three layer architecture to represent service, execution environment and infrastructure functionality.

### BACKGROUND OF THE INVENTION

The Internet has grown in popularity largely because it provides a simple and uniform underlying packet protocol for exchanging data that in turn enables more complex applications to occur. The relative simplicity of the Internet has lead to an explosion of growth in data traffic for business and personal usage. An industry of Internet service providers (ISP) has developed to provide access to the Internet for businesses and homes. Similarly an industry of network service providers (NSP) has developed to build ISP infrastructure. ISPs have invested heavily in purchasing infrastructure equipment from NSPs with the general goal of improving customer service, such as achieving greater and more reliable data transfer rates for customer end points. Thus, ISPs have evolved from low speed analog modem Internet connections provided through dial-up service across the plain old telephone system (POTS) into broadband access provided by cable modems, DSL, and ADSL that are capable of transferring data at substantially higher rates.

Internet access offered by ISPs has become a commodity service with different ISPs typically offering similar access speeds and competing on price points. However, as ISPs gain subscribers to their high-speed broadband access services, the reliability of ISP service, i.e. the ability to transfer data at predictable rates, available at end points has suffered and indeed is often less than the capacity of broadband customer modems. For instance, surges in subscriber use tends to create bottlenecks that slow data transfer rates and use ISP infrastructure inefficiently. This difficulty relates generally to the Internet's architecture which transfers data on a “best effort” basis in which IP packets are generally transferred between routing points without prioritization. This “best effort” architecture is attractive for its simplicity, but creates difficulties for ISPs who desire to distinguish themselves based on the services offered compared to other ISPs.

One manner in which ISPs are working to distinguish themselves is to offer subscribers different types of services. In general terms, a service is the processing of certain data on the network in a predetermined manner with associated billing. However, developing a new service and bringing it operational on an ISP network presents a considerable challenge to NSPs. Typically, infrastructure equipment deployed by NSPs has a set of fixed functions that are difficult and even impossible to change. Such equipment generally must be replaced in order for the ISP's network to support new services which use different functions. Further, an ISP's entire network generally must have compatible equipment deployed throughout or the service will not work, and indeed the ISP network may itself fail.

More complex services are generally difficult to implement on a best effort network architecture, such as the Internet, since best effort networks are generally designed to route packets to destinations on a first come first served basis. An ISP that seeks to provide a new service to subscribers of its best effort network has to design and install hardware and software that generally require a considerable capital investment and time to develop. Even after investing considerable time and capital in the development of a new service, subscriber needs and technology often advance more rapidly than a service deployment cycle, frequently leaving newly deployed services out of date before the services become a revenue source or market differentiator for the ISP. Thus, ISPs who attempt to lead the market by developing and offering new services face considerable risk if a large investment in a new service fails to result in greater revenue or customer satisfaction.

### SUMMARY OF THE INVENTION

Therefore a need has arisen for a system and method which programs network nodes to provide services in a best effort packet-based network.

A further need has arisen for a system and method which defines, deploys, provisions and subscribes services in a best effort packet-based network.

A further need has arisen for a system and method which defines a service to have reduced complexity in applying service packet processing behaviors for different hardware and software configurations.

A further need has arisen for a system and method which provides a simplified interface for designing services.

In accordance with the present invention, a system and method is provided that substantially eliminates or reduces disadvantages and problems associated with previously developed systems and methods for establishing services on a packet-based network. A service creation tool provides an interface for defining a service definition package having packet processing behaviors that enable a service on a packet-based network. A service control center deploys and provisions the service to network nodes so that network processors perform the packet processing behaviors to enable the service on the network.

More specifically, the service creation tool provides a graphical user interface and text editor that allow an operator to create a service in a programmable network language which is a domain specific programming language. The service creation tool compiles the service into a service definition package that includes instructions for deploying, provisioning and subscribing the service to the network. A network processor abstraction layer associated with network processors of the nodes that receive packet processing behaviors of the service enables translation of the programmable network language into code for execution on different types of network processors.

The service control center and the programmable network nodes have a layered software architecture with a service layer, execution environment layer, and infrastructure layer with services deployed for the service layer as service objects to network nodes. In the service control center, the infrastructure layer includes a desktop work station and manager for providing an operator interface to deploy services. A communications services module and event bus cooperate to distribute, configure, monitor performance, and track events of the services deployed to network nodes. The execution environment includes an imperative scripting engine that provides a billing and provisioning interface and cooperates with a service installer to instantiate service objects and provision the service objects to network nodes. The services environment includes a service installation function and service composition function to install services on the network with validation, summarizer, polling configuration, and report modules to aid service installation and track service operation.

One network node that receives services is an advanced traffic processor which classifies, modifies and shapes packets according to predetermined packet processing behaviors defined by a service. The infrastructure layer in the advanced traffic processor includes a communication services module for communicating with a service control center and modules to track logging, software, hardware, and boot status. The execution environment of the advanced traffic processor includes an imperative scripting engine that programs a network processor through a network processor abstraction layer. The network processor abstraction layer ensures that programmable network language packet processing behaviors are appropriately translated for operation on the network processor independent of the type of network processor. A service object manager receives service objects from the service control center and provides the service objects to the imperative scripting engine for operation on the network processor. A statistics manager communicates with the imperative scripting engine and service elements, such as PPM, poller and summarizer modules, to provide statistics to the service control center for tracking monitoring and updating the services on the advanced traffic processor.

The use of layered architecture allows an efficient representation of services and their interaction with network elements. An infrastructure layer provides support for system management, such as boot, monitoring and software update. The infrastructure layer communicates with an execution environment layer which provides an adaptable and flexible middle layer to implement a wide variety of techniques that span a range of complexity and function to support specific hardware and software functionality at network nodes. The execution environment layer communicates with a service layer which includes rules and programs that encode services for execution on software and hardware in cooperation with the execution environment layer.

Services are defined in the service layer with an interface provided through the service creation tool. A graphical user interface provides a simple graphical presentation for designing services. In one embodiment, rule based services are defined by identifying an application, qualifiers and actions through the graphical user interface which are translated to a programmable network language and compiled as a service definition package. In an alternative embodiment, the graphical user interface presents a library window with tabs and a service window that allow an operator to drag and drop service selections into the service window. For instance, shape, classify, modify and queue tabs each have service option windows that the operator can select for inclusion in a service. For instance, a queue service selection window is presented when the queue tab of the library window is selected, allowing the operator to drag and drop a queue for association with a desired packet processing behavior. Thus, a programmed service might associate a desired queuing, such as a best effort queue, with an identified IP address. Alternatively, higher priority queues may be identified for packets classified according to IP address or application.

The present invention includes a number of important technical advantages. One important technical advantage is that the service creation tool allows simplified design of services with packet processing behaviors such as flow identification, quality of service, bandwidth management, billing, operational support, event notification, and application proxy. Libraries support programming of desired service packet processing behaviors in a standardized manner with a programmable network language that is compiled into a service definition package.

Another important technical advantage of the present invention is that service definition packages define services for deployment through a service control center with minimized risk of programming errors and network incompatibility. The service control center acts as a single control point for deploying provisioning and subscribing services across a programmable network without extensive operator involvement.

Another important technical advantage of the present invention is that a network processor abstraction layer translates service packet processing behaviors from a common programmable network language so that hardware and software architectures of varying types are easily coordinated to interact for achieving desired services. The service control center maintains a repository of compiled programmable network language services and installs services with object oriented programming techniques. Services are thus updated and maintained in a coordinated fashion that lessens the risk of difficulties on the network.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 depicts a block diagram of a programmable network;

FIG. 2 depicts steps accomplished to deploy and provision a service to programmable nodes of a programmable network;

FIG. 3a depicts the relationship of software architecture layers between a service control center and a network node;

FIG. 3b depicts a block diagram of a layered software architecture for a programmable network node;

FIG. 4 depicts a block diagram of the architecture of a service control center;

FIG. 5 depicts a block diagram of the architecture of a advanced traffic processor programmable network node;

FIGS. 6a, 6b and 6c depict a graphical user interface for programming a rules based service; and

FIG. 7 depicts a graphical user interface for defining a service with a library and tabs.

### DETAILED DESCRIPTION OF THE INVENTION

Preferred embodiments of the present invention are illustrated in the figures, like numerals being used to refer to like and corresponding parts of the various drawings.

Building a service for a network presents a substantial task which is often time consuming and expensive. For instance, years often pass from the development and approval of a business case through the design and provisioning of a service on a network. The conventional development and provisioning of a service on a best effort packet-based network, such as the Internet or intranets that use Internet Protocol, are difficult to design and deploy, typically requiring design from scratch and custom equipment. Even once a service is deployed on a best effort network, modification of the service over time presents a continuing problem.

One solution that eases the development and deployment of services on a best effort network is to deploy programmable nodes on the edges of the network, such as the advanced traffic processor disclosed in U.S. patent application Ser. No. 09/875,639, entitled “A System and Method for Allocating Bandwidth Across a Network,” incorporated herein by reference. One architecture of such a programmable node is described in U.S. patent application Ser. No. 09/897,189, entitled “System and Method for Processing Network Packet Flows,” incorporated herein by reference. A programmable node is a hardware device that processes network packet flows at line speeds at the ingress points of an intranet. For instance, services are provisioned to the intranet by programming the programmable nodes switches to classify, modify, and shape packets to accomplish the desired service.

Generally, a service is a packet processing behavior or behaviors and associated billing rules which provides value to subscribers to the service. Services are provided by software running on programmable nodes that classify, modify, shape, monitor, and/or bill for traffic transmitted across a packet-based computer network. The present invention provides a method and system that defines service programs, deploys the service to the network, and subscribes the service to customers efficiently and reliably through easily understood interfaces.

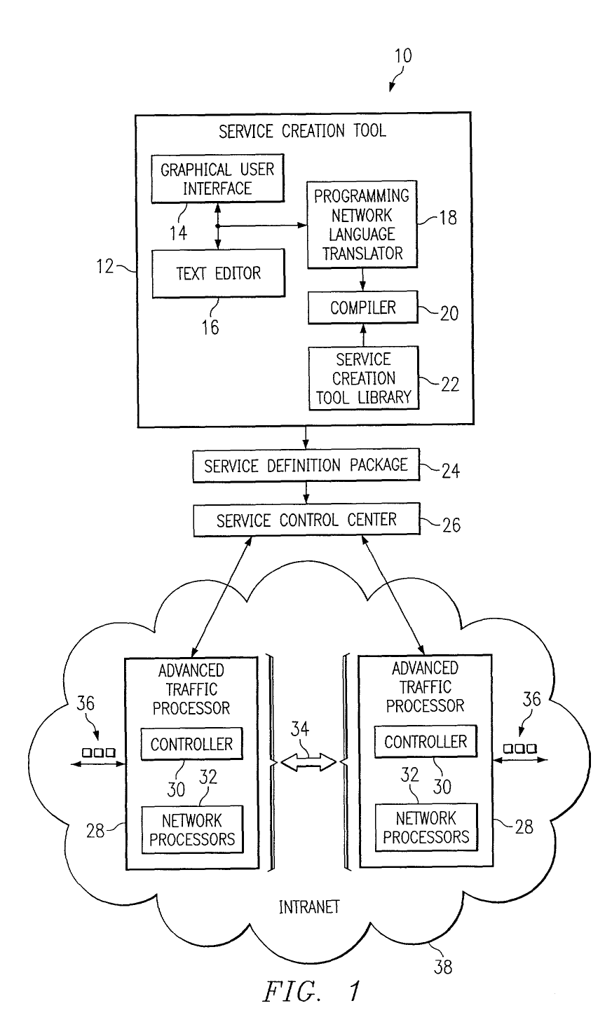

Referring now to FIG. 1, a block diagram depicts a service creation system 10 for creating, deploying, provisioning and subscribing a service to a programmable network. A service creation tool 12 provides an integrated development environment to create value added services through a collection of development tools that create and de-bug programs written in a programmable network language. A graphical user interface 14 allows “drag and drop” processing modules to define a new service. Alternatively, a text editor 16 provides text editing for defining a service. A programmable network language translator 18 accepts services defined by graphical user interface 14 and text editor 16 and translates the services into a network processor programming language that is independent of hardware and software type and defines and enhances deployment of the service. A compiler 20 accepts the service in the programmable network language and compiles the service to useable code with the aid of a service creation tool library 22 that defines commonly used functions. For instance, service creation tool library 22 includes functions to create quality of service tunnels and route traffic through the tunnels, create and use bandwidth allocations and traffic mixing, define standard packet classifications, define standard accounting functions, recognize traffic from particular applications, and create customer reports.

Service creation tool 12 outputs service definition package 24, which is a software program that defines a service including steps for deploying, instantiating, and subscribing the service. A service is a collection of packet processing behaviors and billing rules to which customers associated with a network can subscribe. The packet processing behaviors are installed on broadband nodes, such as advanced traffic processors 28, to classify, process, and shape traffic flowing through a network. In addition to defining packet processing behaviors, service creation tool 12 also defines in service definition package 24 parameters, management variables, report definitions, customer subscription desktops, performance desktops, and service instantiation desktops.

Three types of parameters in service definition package 24 include system parameters with global or node specific variables, service parameters that are instance variables of service instances, and customer parameters that are instance variables of customer instances. The management variables define data tracked by the service for management purposes, such as warning, error, and critical thresholds that trigger alarms. Report definitions define reports available to network operators. The customer subscription, performance, and service instantiation desktops allow network operators to define and view customer and service parameters and management variables and to obtain reports.

Service definition package 24 is transferred to a service control center 26 that provides unified control of advanced traffic processors 28 within the service providers network, such as an ISP intranet 38. Service control center 26 provides network operators with a single point from which the operators perform the monitoring of advanced traffic processors 28 for performance and failures, the configuring of policies, the mapping of users and applications to policies, and the collecting of metering data or billing. Service control center 26 is supported on a server interfaced with intranet 38 to communicate with network elements such as advanced traffic processor 28. Service control center 26 provides a repository of compiled service definition packages 24 and handles the installation and operation of services defined by service definition packages 24.

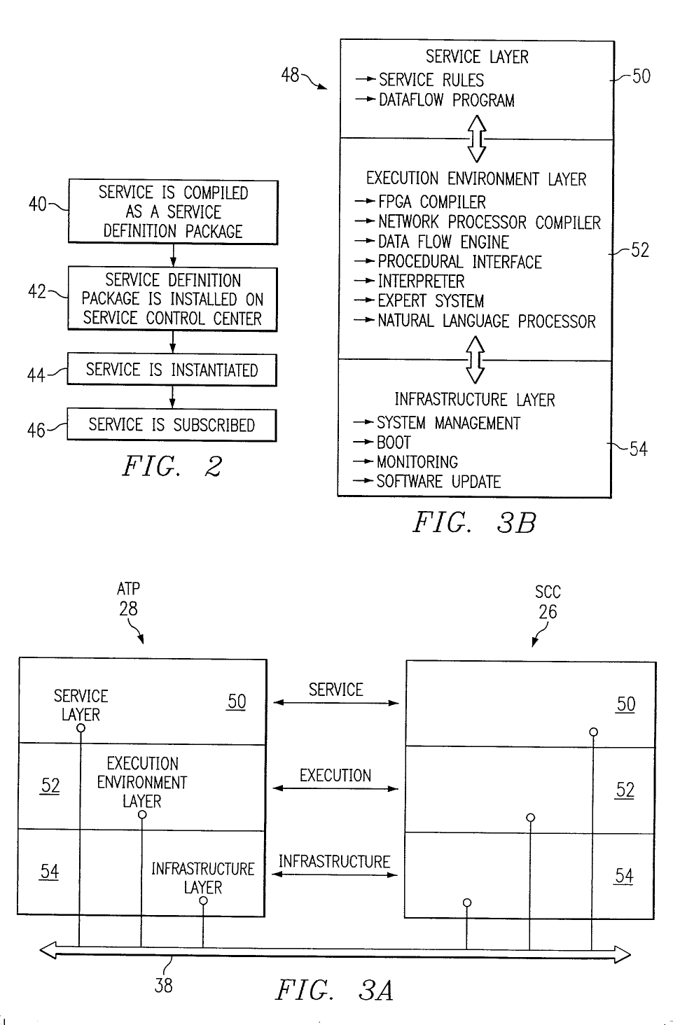

Referring now to FIG. 2, a flow diagram depicts the steps for deploying a service on a network. At step 40, service creation tool 12 defines the service and compiles the service as a service definition package 24. At step 42, the service definition package is installed on service control center 26. For instance, service definition package 24 may be downloaded via a network connection or transferred by storage on a CD ROM. At installation, the service associated with service definition package 24 is validated by service control center 26 and prepared for deployment to network elements.

At step 44, the service associated with a service definition package 24 is instantiated on the network. Service control center 26 creates tables in a database for tracking the service, defines required parameters, and defines required hardware for the service. Service control center 26 determines the network elements that require updating to support the service and downloads appropriate service code to the elements. For instance, service control center 26 downloads packet processing behaviors, billing rules, parameters, and variables for the service to a controller 30 of one or more advanced traffic processors 28. Controller 30 applies the downloaded service information to program network processors 32 to classify, process, and shape packets 36 so that advanced traffic processors 28 transfer packets through one or more tunnels 34 to accomplish the desired service. At step 46, the service is subscribed by subscribing customers with the definition of customer parameters. Subscribed customers receive the service on intranet 38 and are billed if appropriate by associated billing rules.

Referring now to FIGS. 3A and 3B, block diagrams depict the software architecture for programming nodes with a service. FIG. 3A depicts the relationship between software architecture layers for a service deployed to a programmable network having a service control center 26 and an advanced traffic processor network node 28. A service layer 50 defines service rules for accomplishing the service at each programmable node. Service layer 50 communicates with an execution environment layer 52 which provide functions for accomplishing rules defined in service layer 50. Execution environment layer 52 communicates with an infrastructure layer 54 which provides basic management functions for the programmable node. Each layer communicates through network 38 with respective layers of other programmable nodes. For instance, as depicted by FIG. 3A, service layer 50 of ATP 28 communicates through the execution environment and infrastructure layers of ATP 28 and SCC 26 in order to communicate with the service layer 50 of SCC 26.

The block diagram of FIG. 3B depicts the functionality associated with layers of the software architecture for enabling a service deployed to an advanced traffic processor 28. The ATP 28's software architecture is broken into three layers, a service layer 50, an execution and environment layer 52 and an infrastructure layer 54. Infrastructure layer 54 provides basic system management functions, such as boot, monitoring, and software update functions in communication with execution environment layer 52. Execution environment layer 52 provides an adaptable and flexible middle layer which can be implemented with a wide variety of techniques that span a wide-range of complexity and function. For example, services are supported for specific advanced traffic processor hardware and software functions by using the execution environment layer 52 to communicate with infrastructure layer 54 and service layer 50. Execution environment layer 52 may include an FPGA compiler, a network processor compiler, a data flow engine, a procedural interface such as a C API, an interpreter, an expert system, or a natural language processor.

Service layer 50 provides service rules and data flow programs to support services encoded as programs for the execution environment layer 52. For example, if the middle layer is an expert system then the service is encoded as a set of rules in service layer 50. Alternatively, if the middle layer is a data flow processor, the service is encoded as a data flow program. The execution environment layer 52 translates the service layer 50 programs into representations for execution on an advanced traffic processor 28. This three layer architecture allows network services to be encoded in an efficient representation. For example, the packet processing behavior of a service can be specified as a data flow program while individual elements that comprise the data flow can be specified in other representations, such as an FPGA specification or pattern tree for the network processor. Other functions of a service, such as reporting, can be represented using procedural abstractions such as with Perl or awk. The combined system simplifies the task of modifying or creating network services by allowing the service developer to express the service functions in a language appropriate to the task.

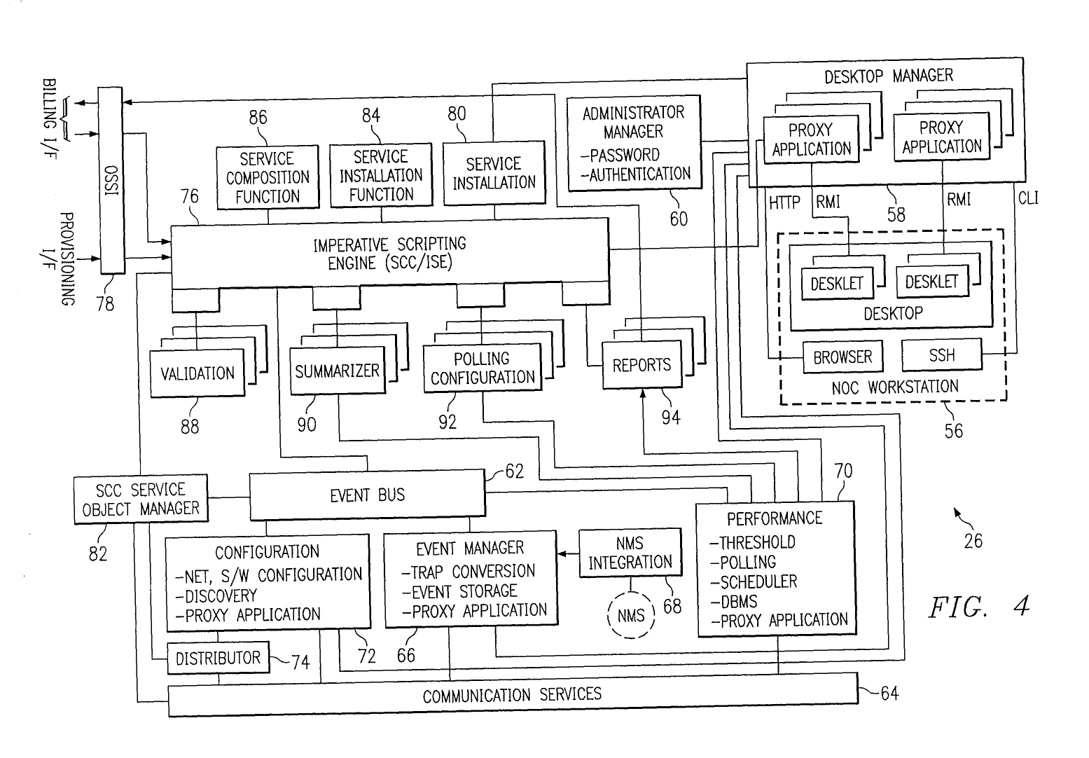

Referring now to FIG. 4, a block diagram depicts a service control center 26 logical architecture for performing element management associated with infrastructure layer 54, establishing a run time environment associated with execution environment layer 52, and deploying and monitoring service rules and dataflow programs associated with service layer 50.

The infrastructure layer 54 supports basic system management and interfaces with the following modules: desktop module 56, desktop manager 58, administration manager 60, event bus 62, communication services module 64, event manager 66, NMS integration module 68, performance module 70, configuration module 72, and distributor 74. These modules maintain basic system management and communication interfaces with other programmable nodes and operators.

Operator access to service control center 26 occurs through a network operating center work station 56 which provides a desktop to support browser and other interfaces for element management, monitoring of run time environment and establishing or modifying services. Work station 56 interfaces with service control center 26 through a desktop manager 58 that provides proxy applications for run time environment monitoring and services.

In service control center 26, the infrastructure layer establishes and maintains a run time environment that allows services to be deployed, monitored, and modified. An administration manager module 60 ensures that access to element management is authorized through a password authentication for security purposes. An event bus 62 cooperates with a communication services module 64 to monitor communications with network elements. An event manager module 66 detects and stores events and communicates with an NMS integration module 68 to provide an interface that integrates existing network management systems. A performance module 70 monitors network element performance based on inputs received from communication services module 64. A configuration module 72 monitors and adjusts configuration of network elements, including software configurations, in cooperation with distributor module 74 which aids the distribution of software updates through communication services module 64.

The execution environment of service control center 26 provides functionality for executing service rules to deploy and provision a service to a programmable network and includes the following modules: an imperative scripting engine, operational support system interface, service installer, service object manager, and a service installer. The execution environment is monitored and maintained through one or more proxy applications associated with desktop manager module 58 and desktop 56.

An imperative scripting engine 76 supports the run time environment with appropriate functionality and enables updates for billing and provisioning information through an operational support system interface 78. A service installer 80 cooperates with scripting engine 76 to place new services in a repository and install the new service. Services are installed as service objects having associated parameters stored in Extensible Markup Language (XML). The execution environment includes a service object manager 82 and calls distributor 74 to download the service object to advanced traffic processors 28 or other network nodes through communication services module 64.

The service layer of service control center 26 includes software modules to deploy and provision services received in a service definition package. The service layer modules include a service installation function, a service composition function, and validation, summarizer, polling configuration, and report modules. Imperative scripting engine 76 supports a variety of service functions and operator interaction through proxy applications of desktop manager module 58. When a new service is installed, imperative scripting engine 76 runs service installation function 84 in cooperation with service installer 80 to create database tables for the service and to define required parameters and hardware for the service. A service composition function 86 determines the composition of the service for instantiation and then validation function 88 is called on service objects to verify that service parameters are legal. In subscribing specific customers, provisioning information is provided through office support system interface 78. For instance, to associate the advanced traffic processor 28 serving a desired MAC\IP address, the desired provisioning data is saved to an Extensible Markup Language file and validated by validation function 88. Once the service is operational on the network, a summarizer function 90, polling configuration function 92, and reports function 94 monitor performance information for billing and updating the run time environment and element management information at network operating center work station 56.

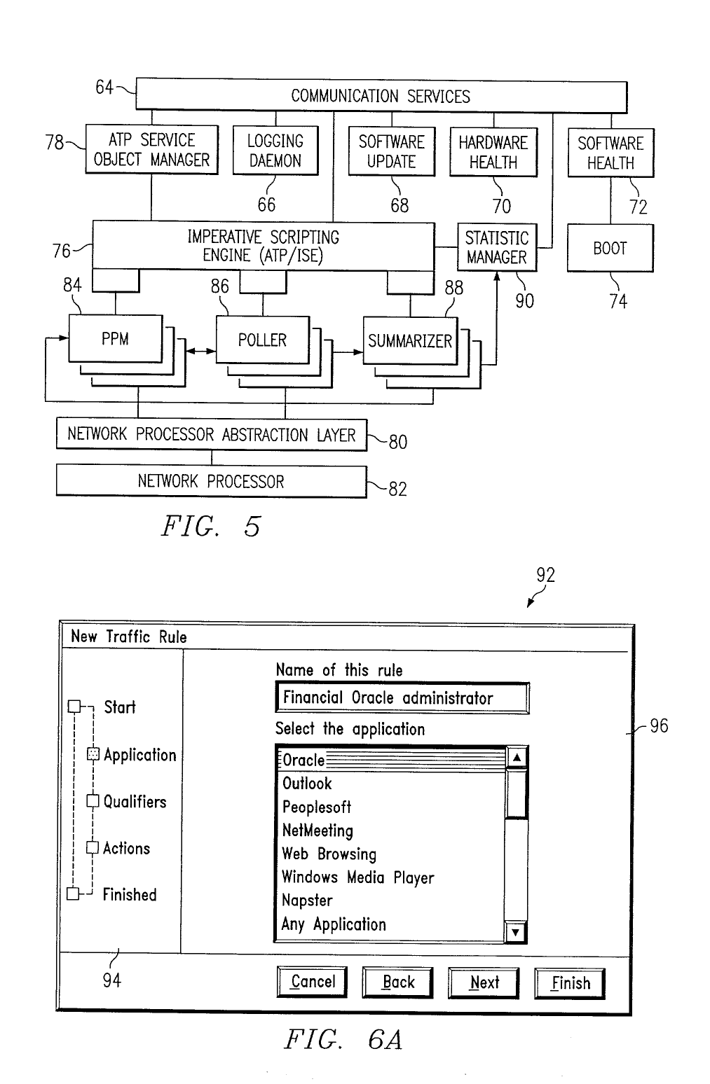

Referring now to FIG. 5, a block diagram depicts the advanced traffic processor software architecture for performing infrastructure, execution environment, and service functions to deploy, run, and monitor services. The ATP infrastructure environment performs basic management functions with a communication services module, logging daemon, software update module, hardware health module, and software health module having an associated boot module. Communication services module 64 supports communications between the service control center 26 and the advanced traffic processor. A logging daemon 66, software update module 68, and hardware health module 70 interface with communication services module 64 to update the service control center on advanced traffic processor status and operations. A software health module 72 and boot module 74 monitors the advanced traffic processor software and boot process.

The execution environment of the advanced traffic processor includes an imperative scripting engine, ATP service object manager, statistics manager, network processor abstraction layer, and network processor. The imperative scripting engine 76 accepts service objects from service object manager 78. Imperative scripting engine 76 provides code for performing services to a network processor abstraction layer 80 which translates programs from a processor independent language to code for operation on a network processor 32 associated with the advanced traffic processor. Network processor abstraction layer 80 enables the use of a common network programming language for different types of node hardware elements by providing independent translation of code to maintain system and software compatibility.

The service layer of the advanced traffic processor includes a packet processing module, poller, and summarizer. Services provided by network processor 32 are monitored by summarizer module 88, poller module 86, and PPM module 84 which reports statistics to statistics manager module 90. These statistics are provided to the service control center through communication services module 64. For instance, the packet processing module installs rules in the network processor through network processor abstraction layer 80. The rules provide packet processing behaviors for classifying, modifying and shaping flows to accomplish a desired service. The rules also are able to create counters, such as to count the number of bytes sent by a particular IP address. Poller 86 periodically uploads the counters and provides them to summarizer 88. Summarizer 88 computes statistics, such as averages, and derived measurements, such as bandwidth usage and the number of bytes transferred over a time interval, and then transfers the statistics through statistics manager 90 of the execution environment.

The present invention provides a number of methods for programming a network to create, deploy and provision services. For instance, an operator interacting with the service control center is able to use simple graphical user interfaces, more complex scripting, or even direct programming of advanced traffic processors in the network programming language. Further, the service control center includes the capability of creating graphical user interfaces along with services so that service end users can define service parameters, deploy a service, and provision a service, such as through an internet browser.

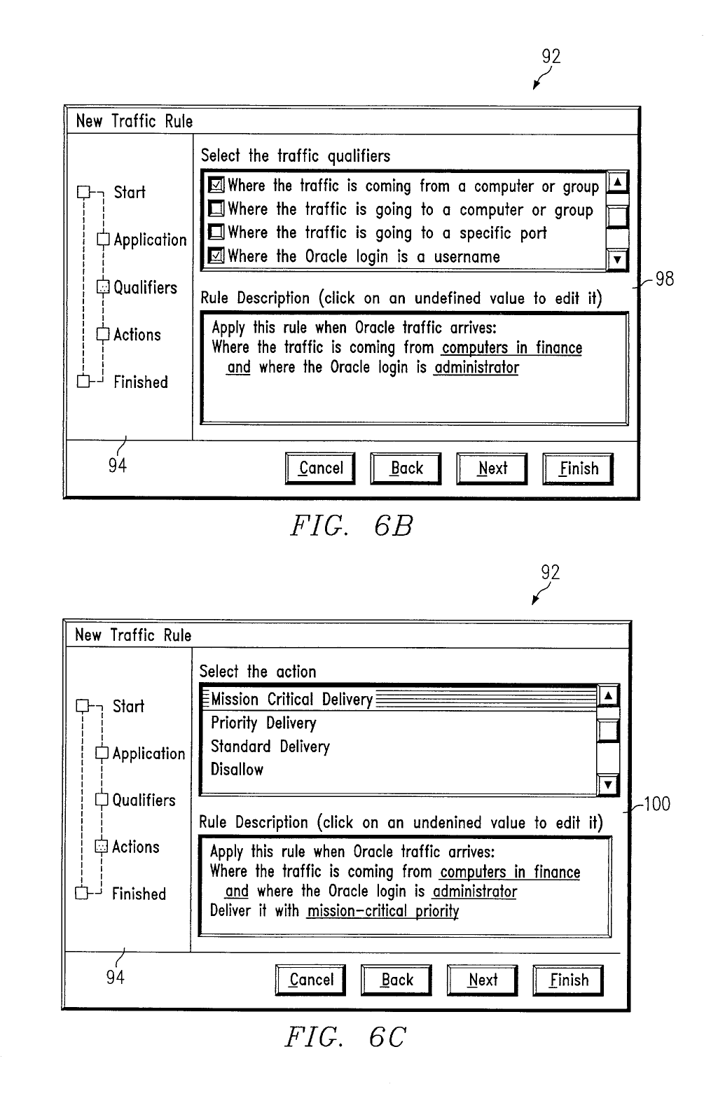

Referring now to FIGS. 6A, 6B and 6C a graphical user interfaces are depicted for programming a rule based service. The graphical user interfaces are created along with a service so that a network operator can prioritize packets associated with predetermined software applications transferred across the network. A rules windows 92 allows an operator of the network to select the application, qualifiers for the application, and actions for the application that will be performed by a rule based service. An application window 96 allows a network operator to select the application or applications to which the rule based service will apply.

Referring to FIG. 6B, a qualifier window 98 allows the network operator to qualify the rules for the selected application. For instance, qualifications include such information as packet origin and destination and user login information. Qualification window 98 of FIG. 6B provides traffic rules for Oracle-based packets coming from computers associated with finance and using an Oracle login. In alternative embodiments, different levels of priority are provided to predetermined applications and traffic sources to allow a network operator to optimize network performance. Thus, for instance, low priority intranet traffic, such as Internet browsing, may be queued as necessary to make sure that higher priority traffic, such a voice over IP or business related applications, proceed through the network with minimal delay. As depicted in FIG. 6C, an actions window 100 allows the network operator to select delivery priority for the identified Oracle packets based on the IP address associated with the packets so that finance related Oracle applications receive priority queuing.

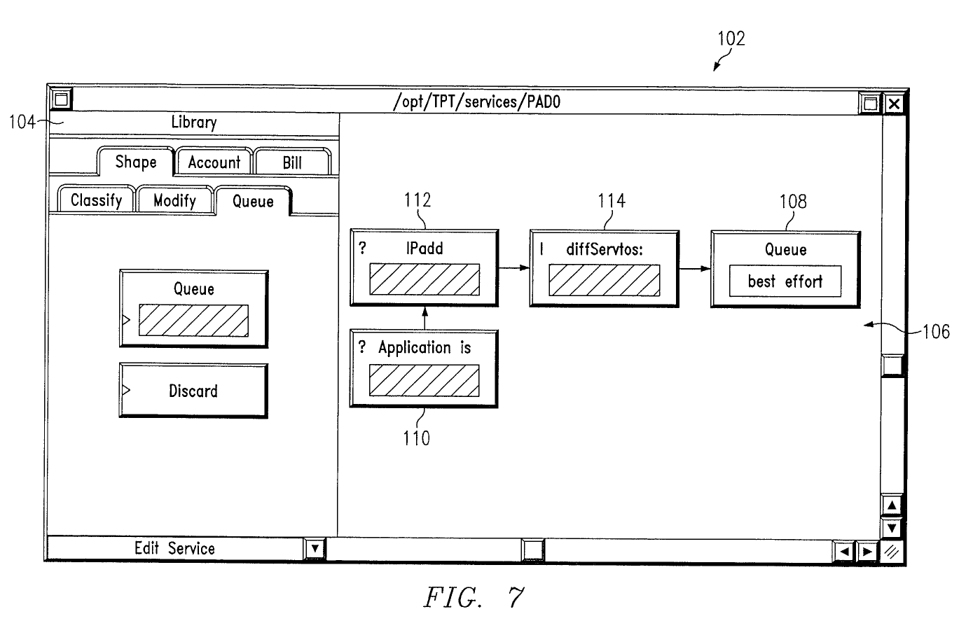

Referring now to FIG. 7, an alternative graphical user interface 102 is depicted for creating a service. A library window 104 provides tabs for selections of options to program shaping, accounting, billing, classifying, modifying and queuing of packets for supporting a desired service. For instance, the operator selects the queue tab in library window 104 and is presented with the options available for queuing of a service. The network operator then drags the selected queue option window to a service window 106 so that packets associated with services defined in service window 106 will queue according to the selected queue option.

In the example depicted by FIG. 7, the queue function 108 presents a bound parameter for the operator to select different queuing options, such as a best effort queue. Parameters 110, 112, and 114 are unbound parameters which are bound later by the service object, for instance at service instantiation or service subscription. Once the service represented in window 106 is deployed to the network, applications defined in the parameter of the application window 110 and originating from the IP address of the IP address window 112 will be classified as belonging to the service and modified with the selected parameter of the diff serve window 114. The classified and modified packets will queue on a best effort basis for transmission across the network. For instance, the service might define Internet browsing as a low priority function that is queued on a best effort basis. Alternatively, the service might define other applications, such as Oracle applications originating from a finance-related IP address as a high priority that is receives reduced delay.

Although the graphical user interface provides a convenient and easy-to-use interface for defining services, additional flexibility is obtained by programming the service through a text editor. The text editor provides additional flexibility when compared with programming through the graphical user interface by allowing direct access to the programmable network language. For instance, the service created in the graphical user interface depicted by FIG. 7 is defined by the text editor as:

Q=new queue (best_effort)

ip=new classifier (ipaddr=customer_ip)

clas=new classifier (application=customer_app)

ds=new diffserv (tos=AF1)

ip→clas→ds→Q

If the application is one not already identified in the service creation library, then the application is added through more detailed programming. In essence, the updating of the library updates the programmable network language to broaden its capability to easily program common packet processing behaviors. More complex functions provide improved flexibility to the programmable network language to allow adaptation as new types of functionality are developed to provide additional services.

Although the present invention has been described in detail, it should be understood that various changes, substitutions and alterations can be made hereto without departing from the spirit and scope of the invention as defined by the appending claims.

What is claimed is:

1. A programmable packet-based network having plural nodes for providing services to network subscribers, the network comprising:
a service creation tool having an operator interface for programming a service definition package, the service definition package having one or more packet processing behaviors defined in a network programming language;
a service control center interfaced with the packet-based network and operable to accept the service definition package for deployment to predetermined network nodes; and
at least one network node interfaced with the network, the node having a network processor, the node operable to perform the one or more packet processing behaviors translated from the network programming language.

2. The network of claim 1 further comprising plural network nodes forming an internet service provider intranet, the packet processing behaviors establishing tunnels between the network nodes.

3. The network of claim 1 wherein the service creation tool interface comprises a graphical user interface for defining services in the network programming language.

4. The network of claim 1 further comprising a network processor abstraction layer associated with each network processor, the abstraction layer operable to translate the network programming language for execution on the associated network processor.

5. The network of claim 1 wherein the service control center comprises a software architecture for programming a network to provide a service, the architecture having a service layer, an execution layer and an infrastructure layer.

6. The network of claim 5 wherein the service comprises a rule-based service, the service layer comprising service rules and the execution environment comprising an expert system.

7. The network of claim 5 wherein the service layer comprises a dataflow program and the execution layer comprises a dataflow processor.

8. The network of claim 7 wherein the service further comprises an FPGA specification and the execution environment layer further comprise an FPGA compiler.

9. The network of claim 7 wherein the service further comprises a network processor pattern tree and the execution environment layer further comprises a network processor compiler.

10. A method for programming nodes of a packet-based network, the method comprising:
defining a service in a programmable network language, the service having at least one packet processing behavior;
compiling the service as a service definition package;
installing the service definition package on a service control center, the service control center interfaced with the packet-based network;
instantiating the service as service objects deployed to one or more network nodes, the network nodes having one or more network processors operable to perform the packet processing behavior; and
translating the packet processing behavior from the service object for operation on the network processor.

11. The method of claim 10 further comprising:
subscribing a network end user customer to the service through the service control center.

12. The method of claim 11 wherein subscribing further comprises:
providing customer parameters from the service control center to the network node, the customer parameters represented as instance variables of customer instances.

13. The method of claim 10 wherein defining the service further comprises:
selecting rules for the service from a graphical user interface; and
translating the selected rules into the programmable network language.

14. The method of claim 13 wherein selecting further comprises:
dragging parameter windows from a library window to a service definition window.

15. The method of claim 14 wherein the library window comprises plural tabs associated with types of packet processing behaviors, the tabs having parameter windows associated with parameters that define a packet processing behavior.

16. The method of claim 15 wherein the tabs comprise a shape tab, a classify tab, a modify tab and a queue tab.

17. The method of claim 10 wherein the packet processing behavior establishes a tunnel between a first and second network node.

18. The method of claim 10 wherein defining the service further comprises defining a service layer, an execution layer and an infrastructure layer.

19. A software architecture for providing a service on a packet-based network comprising:
a service layer having instructions that identify packet processing behaviors for execution by predetermined execution elements of a network node;
an execution environment layer interfaced with the service layer, the execution environment layer representing the network node execution elements to execute instructions from the service layer; and
an infrastructure layer interfaced with the execution environment layer, the infrastructure layer providing management functions to support the network node execution elements.

20. The architecture of claim 19 wherein the service layer comprises a set of rules and the execution environment layer comprises an expert system.

21. The architecture of claim 19 wherein the service comprises a dataflow program and the execution environment layer comprises a dataflow processor.

22. The architecture of claim 21 wherein the service comprises one or more packet processing behaviors specified by the dataflow program, the service further comprising an FPGA specification, and the execution environment layer further comprising an FPGA compiler.

23. The architecture of claim 21 wherein the service comprises one or more packet processing behaviors specified by the dataflow program, the service further comprising a pattern tree for a network processor, and the execution environment layer further comprising a network processor compiler.

24. The architecture of claim 19 having a reporting element, the execution environment further comprising a procedural abstraction of the reporting element.

25. A graphical user interface for programming network nodes of a packet-based network, the graphical user interface comprising:
a library window having plural tabs, each tab having one or more functions represented by windows adapted to identify one or more parameters associated with the functions; and
a service window presented proximate to the library window, the service window adapted to present functions as elements of a service;
wherein the functions of the library window are further adapted for insertion in the service window to define a service.

26. The graphical user interface of claim 25 wherein the library window tabs comprise a queue tab having a queue function window.

27. The graphical user interface of claim 26 wherein the queue function window defines a queuing function for packets associated with a service as a parameter input into the queue function window.

28. The graphical user interface of claim 27 wherein the queue function parameter comprises queuing on a best effort basis.

29. The graphical user interface of claim 27 wherein the queue function parameter comprises queuing packets to have priority transmission across the network.

30. The graphical user interface of claim 26 wherein the queue function window discards packets.

31. The graphical user interface of claim 25 wherein the library window tabs comprise a classify tab having an IP address function window.

32. The graphical user interface of claim 25 wherein the library window tabs comprise a modify tab having a function window that defines a packet modifying behavior.

32. The graphical user interface of claim 25 wherein the library window tabs comprise a shape tab having a function window that defines a packet shaping behavior.
